(19) United States
(12) Patent Application Publication
(10) Pub. No.: US 2009/0252418 A1
(43) Pub. Date: Oct. 8, 2009

(54) DETECTION OF EDGES IN AN IMAGE

(75) Inventor: Henri Bouma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,633

(22) PCT Filed: Mar. 7, 2005
(86) PCT No.: PCT/IB2005/050828

§ 371 Date: Sep. 7, 2006

(30) Foreign Application Priority Data
Mar. 12, 2004 (EP) 04101027.3

(51) Int. Cl. G06K 9/46

(52) U.S. Cl. 382/190

(57) ABSTRACT

A system locates an edge of an object in a two- or three dimensional image, in particular a medical image. Through an input (310) a set of data elements is received representing values of elements of the image. The data set is stored in a storage (320). A processor (340) determines the edge of an object in the image. It calculates at least a first and/or second-order derivative of the data elements and isophote curvatures for the image identified by κ. It also determines a correction factor α that corrects for dislocation of an edge caused by curvature of an object and/or blurring of the data. The correction factor α depends on the isophote curvature κ. The processor then determines a zero crossing of an operator that depends on the calculated derivative and the isophote curvature. An output (330) of the system provides an indication of a location of an edge in the image.

The invention relates to a system for locating an edge of an object in a two- or three-dimensional image, and to a method of locating an edge of an object in a two- or three-dimensional image. The invention further relates to software for use in such method.

For many industrial and biomedical applications of digital image processing, it is very important to locate edges in an image accurately. Such applications include pattern recognition (e.g. recognition of text or objects in an image), X-ray inspection of objects that can not be opened easily in the time available (e.g. inspection by customs authorities), inspection of the quality of manufactured product (e.g. inspection of printed circuit boards, ICs, metal fatigue, etc.). An important application area of edge detection is formed by clinical applications of medical imaging. For example, in the diagnosis of a vascular disease, the grading of stenoses is an important factor in determining the treatment therapy. It is thus required to accurately determine edges.

Object boundaries (i.e. edges) can be detected with first- and second-order derivatives. The gradient, i.e. a vector of first-order derivatives, may indicate the presence of an edge and the maximum of the gradient magnitude is commonly used to locate edges. The zero-crossings of the second-order derivative in the gradient direction (L_{ww}) are located where the gradient magnitude is maximal. An edge detector based on this principle is sometimes referred to as the “Canny” detector. Also frequently used is the so-called “Marr-Hildreth” edge detector that uses the zero crossings of the Laplacian (ΔL=Lₓₓ+L_{yy}+L_{zz}) to locate edges. The Laplacian is easy to calculate, but the zero crossings are not located where the gradient is maximal.

Defining the ‘edge’ of an object as the position where the gradient is maximal in the image data set, it is known that both methods locate the edge of planar surfaces correctly. The zero crossings of L_{ww} will also locate the edge correctly for surfaces that are not planar but curved. The edge detection based on ΔL will cause a dislocation of the edge. These statements hold if the edge is defined as the edge in the acquired image, as represented by a 2D or 3D (volumetric) data set. For medical applications, the 2D data sets are typically acquired by an X-ray or ultra-sound imaging device. Volumetric data sets are typically acquired using 3D scanners, such as CT (Computed Tomography) scanners or MR (Magnetic Resonance) scanners. Defining the ‘edge’ as the position of the actual edge of an object in the real world before acquisition, both methods give a dislocation of curved edges. The dislocation is caused by a blurring effect during the acquisition. Inherent to the acquisition of an image is that a part of an image being acquired that in principle should be mapped to one element (e.g. pixel) of an image in fact contributes to more than one element. The acquired data sets of some imaging modalities (e.g. computed tomography CT) can be modeled by rather-homogeneous objects convolved with a point-spread function (PSF). In CT, the PSF can be approximated by a Gaussian distribution with standard deviation σ. The blurring causes conventional edge-detection methods to locate edges inaccurately, leading to errors in quantification (e.g. giving the diameter of a blood vessel) and visualization (e.g. rendering a blood vessel on a display).

It is normally desired to find the location of the edge before blurring instead of finding the points with the maximal gradient in the blurred image. If the edge of a circular object with radius R is not defined as the position where the gradient is maximal, but as the position before blurring, both methods (ΔL and L_{ww}) give a dislocation of curved edges. The location of the zero crossings r of these methods goes in opposite directions. This is illustrated in FIG. 1 for a real edge with radius R indicated as a circle 100. ΔL gives an overestimation of the radius (shown using a solid black disc 110) and L_{ww} gives an underestimation of the radius (shown using a solid black disc 120). The dislocation (r−R) is caused by the curvature and the blurring. Because ΔL and L_{ww} appear to be dislocated in the opposite direction, it is known to use the so-called Plus operator, which sums ΔL with L_{ww} and reduces the dislocation of curved edges. The Plus operator is described in L. J. van Vliet and P. Verbeek, “On the location error of curved edges in low-pass filtered 2D and 3D images”, IEEE Trans. Pattern Anal. Machine Intell., vol. 16, pp. 726-733, July 1994. The Plus operator results in an edge detector that locates the edges more accurately. This is illustrated in FIG. 1 using a solid black disc 130. FIG. 2 shows the results of the three methods for objects with a relatively small curvature. However, if the surface is curved too much (e.g. for very small curved objects) the performance of the Plus operator also decreases. It is desired to be able to accurately locate very small objects in an image, such as a blood vessel of only a few pixels wide. Such small objects have a relatively high curvature and edges of such objects can not be accurately located by the described methods.

It is an object of the invention to provide an edge detector and method of detecting an edge that are better capable of detecting edges of objects with a high degree of curvature.

To meet an object of the invention, the system for locating an edge of an object in a two- or three-dimensional image includes:

an input for receiving a set of data elements representing values of elements of the image;

a storage for storing the data set;

an output for providing an indication of a location of an edge in the image; and a processor for, under control of a computer program, processing the data set to determine the edge of an object in the image by: calculating at least a first- and/or second-order derivative of the data elements; calculating isophote curvatures for the image where the curvatures are identified by κ; determining a correction factor α that corrects for dislocation of an edge caused by curvature of an object and/or blurring of the data; the correction factor α depending on the isophote curvature κ; and determining a zero crossing of an operator that depends on the calculated derivative and the isophote curvature.

The inventor had the insight that the known edge detectors can be improved by using a correction factor that depends on the isophote curvature κ. By not only using local derivatives but also the local isophote curvature, the edge can be determined more accurately, in particular for objects with a relatively high curvature, such as small objects.

According to the measure of the dependent claim 2, the image has been acquired with an acquisition device that causes acquired data to be blurred and the correction factor α also depends on a degree of blurring of the image. As described in the dependent claim 3, the blurring may substantially correspond to a convolution with a Gaussian point-spread function with a standard-deviation σ and the correction factor α then depends on the standard-deviation σ of the Gaussian blurring function. In this way, the dislocation of the edges caused by the blurring can be corrected better. An image with a larger degree of blurring (e.g. an image acquired with large detectors) is corrected differently than an image with a smaller degree of blurring (e.g. an image acquired with small detectors). In simple systems, a fixed value may be used for the degree of blurring and the correction factor α can be fixed for this value.

According to the measure of the dependent claim 4, the processor is operative to determine for the image an associated estimated degree of blurring and to load for the image a correction factor function associated with the degree of blurring for the image; the correction factor function giving for an isophote curvature input value a corresponding correction factor value. In this way, for a specific image a simpler correction factor can be used. Preferably, the correction factor function is given in the form of a look-up table, where isophote curvature κ is the index. The correction factor function may be empirically determined for the chosen derivative(s). Preferably, the correction factor function is at least partly analytically determined by for a given isophote curvature and standard-deviation minimizing the edge dislocation.

According to the measure of the dependent claim 5, the derivative is a Gaussian derivative and the operator is given by: L_{ww}−ακL_{w}, where w is a gradient direction.

This operator, for suitably chosen α, outperforms the known edge detectors.

According to the measure of the dependent claim 6, for a 2D image, α is given by:

$$α ( σ , κ ) = 1 + {( \frac{1}{σκ} )}^{2} ( 1 - \frac{{I}_{0} ( {( \frac{1}{σκ} )}^{2} )}{{I}_{1} ( {( \frac{1}{σκ} )}^{2} )} )$$

where Iₙ( ) is the modified Bessel function of the first kind.

In this way, the systematic error in dislocating the edge is fully removed.

According to the measure of the dependent claim 7, for a 3D image the isophote curvature κ includes a first curvature component κ₁ in a direction of a highest absolute value of the curvature and a second curvature component κ₂ in a direction perpendicular to κ₁, the correction factor α depending on κ_{Σ}=κ₁+κ₂.

Such a correction factor can fully remove the systematic error in dislocating the edge of a ball-shaped object and a cylinder-shaped object. Such an edge detector is, for example, very suitable for identifying and quantifying the diameter of tubular structures, such as blood vessels.

According to the measure of the dependent claim 8, the correction factor α further depends on

$$\frac{{κ}_{1}}{{κ}_{2}} .$$

Such a correction factor can also improve detection of more complex 3D objects. By using

$${κ}_{Σ} = {κ}_{1} + {κ}_{2} and \frac{{κ}_{1}}{{κ}_{2}}$$

it is possible to represent the correction factor, for a given standard-deviation, as a two-dimensional look-up table.

To meet an objective of the invention, a method of locating an edge of an object in a two- or three dimensional image includes:

receiving a set of data elements representing values of elements of the image;

calculating at least a first- and/or second-order derivative of the data elements;

calculating isophote curvatures for the image where the curvatures are identified by κ;

determining a correction factor α that corrects for dislocation of an edge caused by curvature of an object and/or blurring of the data during acquisition; the correction factor α depending on the isophote curvature κ; and

determining the edge of an object in the image at a location that corresponds to a zero crossing of an operator that depends on the calculated derivative and the isophote curvature.

These and other aspects of the invention are apparent from and will be elucidated with reference to the embodiments described hereinafter.

### IN THE DRAWINGS

FIG. 1 shows the performance of prior art edge detectors;

FIG. 2 shows a graph comparing prior art edge detection methods for low curvature;

FIG. 3 shows a block diagram of an image acquisition and processing system in which the invention may be used;

FIG. 4 shows a graph of function a for circular objects (disks) in 2D;

FIG. 5 shows a graph of function a for ball (3D);

FIG. 6 shows a graph of function a for a toroidal object (donut) as a model of a curved vessel (3D); and

FIG. 7 shows a graph comparing prior art edge detection methods with the method according to the invention for high curvature.

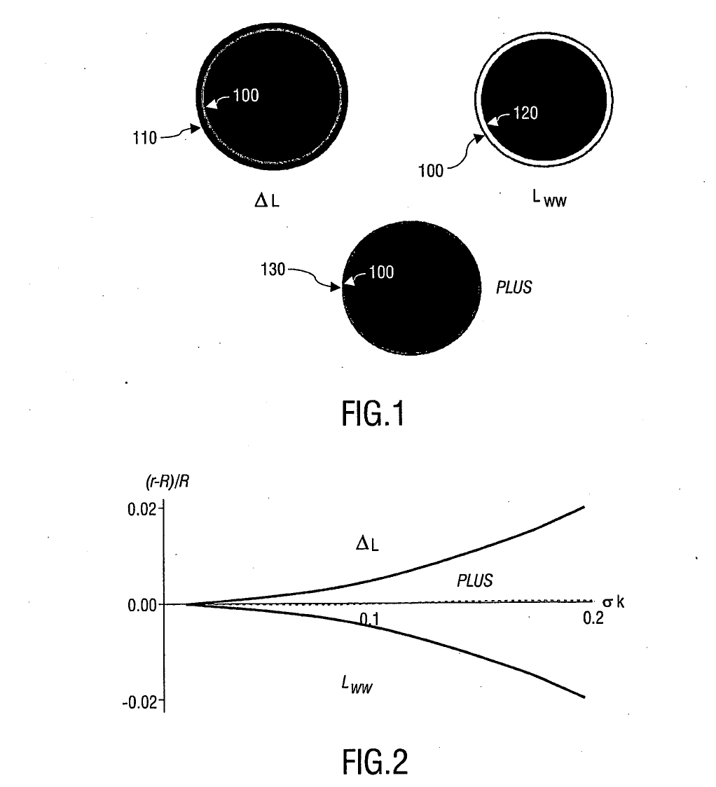

comparing prior art edge detection methods for low curvature;

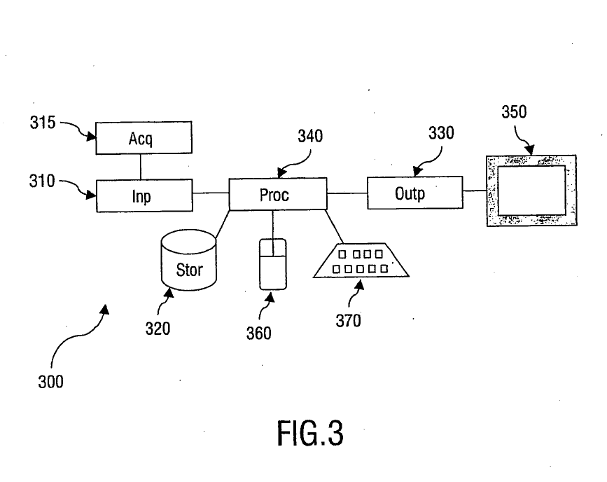

FIG. 3 shows a block diagram of the system according to the invention. The system may be implemented on a conventional computer system such as a workstation or high-performance personal computer. The system 300 includes an input 310 for receiving an image. In practice, the image is two-dimensional (2D) or three-dimensional (3D, also referred to as volumetric). The input 310 receiving a set of data elements representing values of elements of the image. For a 2D image, the data elements may be pixels (picture elements). For a 3D image, the data elements may be voxels (volume elements). The data may be supplied via any local or wide area network (like Ethernet or ISDN, respectively), or another data carrier (like a compact disk). Many hospitals have installed a picture archiving and communication system (PACS) to supply data. In FIG. 3, the image is acquired by an image acquisition device 315, such as medical MR or CT scanner. Such acquisition device 315 may be part of the system 300, but may also be external to the system.

The system also includes a storage 320 for storing the data set. Preferably, the storage is of a permanent type, such as a hard disk. In practical implementations, the edge detection method according to the invention will be performed by a processor 340 for, under control of a computer program, processing the data set to determine the edge of an object in the image. Of course, the processor does not have to be a general-purpose processor, but it can also be application specific hardware to optimize speed. Usually, the processor will locate many edge points that together form the edge. The program may be loaded from a permanent storage, such as storage 320, into a working memory, such a RAM for execution. An output 330 of the system is used for providing an indication of a location of an edge in the image. It may indicate the edge in any suitable way. For example, it may supply a filtered image, wherein the edges are clearly indicated by zero crossings. Alternatively, the output may be supplied as a surface-rendered (bit-mapped) image for display. The display 350 may, but need not be part of the system. The system may be able to provide simultaneously two 2D images for stereoscopic display. If so, two images are produced from two different viewpoints, each corresponding to a respective eye of a viewer. Instead of or in addition to supplying a filtered image for rendering, the output may provide an electronic representation of the edge points (e.g. list of edge coordinates or other suitable description of a curved line) so that measurements may be performed based on the located edges (e.g. width of blood vessels may be measured). The system as such can be implemented on any suitable computer hardware, such as a workstation.

The system may be controlled by a human operator for example through an input device, such as a mouse 360 and a keyboard 370. Also voice control may be used.

The system and method according to the invention include determining an edge point in an image in the following way:

1. calculating at least one first- and/or second-order derivative of the data elements;
2. calculating an isophote curvature κ for the data elements of the image;
3. determining a correction factor α that corrects for dislocation of an edge caused by curvature of an object and/or blurring of the data during acquisition. The correction factor α depends on the isophote curvature κ;
4. determining a zero crossing of an operator that depends on the calculated derivative and the isophote curvature.

### Notation

Equations used to describe preferred embodiments use the following notation. Coordinates in the Cartesian coordinate system will be indicated as x and y, for 2D images, and x, y and z for 3D images, as is conventional. Partial derivatives will be denoted by subscripts, as in Mₓ for

$$\frac{\partial M}{\partial x} and {L}_{yy} for \frac{{\partial }^{2} L}{\partial {y}^{2}} .$$

In the exemplary equations, derivatives are calculated in a locally fixed coordinate system (gauge coordinates). The vector w is defined in the direction of the gradient and vector v is perpendicular to w. For a 3D image, the third orthogonal vector is indicated as u. So, L_{ww} is the second-order derivative in the gradient direction. The first order derivative in the gradient direction L_{w} is equal to the gradient magnitude and the first order derivative tangential to the iso-surface Lᵥ is equal to zero. The term isophote will be used for a curve through the image of elements with the same intensity. The isophote curvature in 2D is the curvature of the isophotes. The isophote curvature will be indicated by a value κ. In 3D, the isophote curvature κ consists of two components: the principal curvatures κ₁ and κ₂. The vectors corresponding to these values are perpendicular to the gradient and perpendicular to each other. The sum of principal curvatures, will be denoted as κ_{Σ}=κ₁+κ₂.

### Calculating the Derivatives

In principle, any suitable method may be used for calculating derivatives, such as central differences, intermediate differences, the Roberts method, the Prewitt method, or the Sobel method. In a preferred embodiment described below Gaussian derivatives will be used. Thus, Gaussian operators can be used to calculate the derivatives. The Gaussian is preferred because it is rotationally invariant, and it gives an optimal balance between noise suppression and blurring. It is fast for implementation due to separability. Differential operators based on the Gaussian will give exact measurements of the derivatives in the blurred image. They are used as approximating filters, in scale spaces and for noise removal. The standard deviation of the Gaussian operator will be denoted as σₒₚ. As will be described in more detail below, in a preferred embodiment blurring caused by the acquisition is modeled by a Gaussian point-spread function. The standard deviation of this blurring function is denoted as σ_{psf}. Derivatives up to second order can be calculated at a certain scale, using convolution with the Gaussian and Gaussian derivatives. The total standard deviation is then given by: σ=\sqrt{σ²_{psf}+σ²ₒₚ} (semi-group property). This property is another advantage of using Gaussian derivatives: no other type of disturbance is introduced; the total blurring is still Gaussian blurring.

First order derivatives can be used to determine the gradient magnitude, the direction of the gradient etc. (L_{w} is the first-order derivative in the direction of the gradient). In the preferred embodiment, the following first-order derivatives will be used:

2D: L_{w}=\sqrt{Lₓ²+L_{y}²}, Lᵥ=0

3D: L_{w}=\sqrt{Lₓ²+L_{y}²+L_{z}²}, Lᵥ=0, Lᵤ=0

The Hessian (matrix of second-order derivatives) can be used to obtain the preferred second-order derivatives (in the direction of the gradient). This is done by rotating the Hessian so that the first component will be the second-order derivative in the direction of the gradient.

In 2D this gives:

$$\begin{matrix} Hessian = \{ \begin{matrix}{L}_{xx} & {L}_{xy} \\ {L}_{xy} & {L}_{yy}\end{matrix} \} {}^{rotate} \{ \begin{matrix}{L}_{ww} & {L}_{vw} \\ {L}_{vw} & {L}_{vv}\end{matrix} \} ; \\ {L}_{ww} = \frac{{L}_{x}^{2} {L}_{xx} + 2 {L}_{x} {L}_{xy} {L}_{y} + {L}_{y}^{2} {L}_{yy}}{{L}_{x}^{2} + {L}_{y}^{2}} ; \\ {L}_{vv} = \frac{{L}_{y}^{2} {L}_{xx} + 2 {L}_{x} {L}_{xy} {L}_{y} + {L}_{x}^{2} {L}_{yy}}{{L}_{x}^{2} + {L}_{y}^{2}} ; \\ Δ L = Trace ( Hessian ) = {L}_{xx} + {L}_{yy} = {L}_{ww} + {L}_{vv} ; \\ κ = - \frac{{L}_{vv}}{{L}_{w}} = \frac{{L}_{ww} - Δ L}{{L}_{w}} .\end{matrix}$$

In 3D this gives:

$$\begin{matrix} Hessian = \{ \begin{matrix}{L}_{xx} & {L}_{xy} & {L}_{xz} \\ {L}_{xy} & {L}_{yy} & {L}_{yz} \\ {L}_{xz} & {L}_{yz} & {L}_{zz}\end{matrix} \} {⇒}^{rotate} \{ \begin{matrix}{L}_{ww} & {L}_{vw} & {L}_{uw} \\ {L}_{vw} & {L}_{vv} & {L}_{uv} \\ {L}_{uw} & {L}_{uv} & {L}_{uu}\end{matrix} \} = \{ \begin{matrix}{L}_{ww} & … \\ ⋮ & {H}_{T}\end{matrix} \} ; \\ {L}_{ww} = \frac{{L}_{x}^{2} {L}_{xx} + {L}_{y}^{2} {L}_{yy} + {L}_{z}^{2} {L}_{zz} + 2 {L}_{x} {L}_{xy} {L}_{y} + 2 {L}_{x} {L}_{xz} {L}_{z} + 2 {L}_{y} {L}_{yz} {L}_{z}}{{L}_{x}^{2} + {L}_{y}^{2} + {L}_{z}^{2}} ; \\ Δ L = Trace ( Hessian ) = {L}_{ww} + {L}_{vv} + {L}_{uu} = {L}_{xx} + {L}_{yy} + {L}_{zz} .\end{matrix}$$

### Calculating the Isophote Curvature

In 2D, the isophote curvature is defined as:

$$κ = - \frac{{L}_{vv}}{{L}_{w}} .$$

Using the definitions given above, the isophote curvature can be calculated as follows:

$$κ = - \frac{{L}_{vv}}{{L}_{w}} = \frac{{L}_{ww} - Δ L}{{L}_{w}} .$$

In 3D, the principal components of the isophote curvature can be determined by taking the eigenvalues (κ₁, κ₂) and the eigenvectors (for the principal directions) of the submatrix H_{T}, which is tangential to the iso surface:

$$\{ {κ}_{1} , {κ}_{2} \} = eigenvalue ( {H}_{T} ) , \\ \{ v {κ}_{1} , v {κ}_{2} \} = eigenvector ( {H}_{T} ) , \\ {κ}_{Σ} = {κ}_{1} + {κ}_{2} = \frac{{L}_{ww} - Δ L}{{L}_{w}} .$$

Instead of rotating the Hessian matrix and calculating the eigenvalues of the submatrix, other suitable equations can be used for implementation.

### The Operator

It will also be appreciated a choice can be made for the operator that is corrected. The chosen operator will use first and/or second derivatives. In the preferred embodiment described in more detail below, the Plus operator will be used as the starting point. Equally well the Laplace operator or other suitable operator could be optimized.

According to the invention, the operator a correction factor α is determined that corrects for dislocation of an edge caused by curvature of an object and/or blurring of the data during acquisition. The correction factor α depends on the isophote curvature κ. It will be appreciated that the correction factor depends on the operator being used. Using an analytical approach, the corrected operator will be the same or similar. Using an, empirical approach for determining the correction factor, the outcome in practical circumstances may be very similar to the preferred embodiment described below, but may appear different.

In a preferred embodiment, the following operator is used: L_{ww}+αLᵥᵥ which is the same as L_{ww}−ακL_{w}.

### The Correction Factor

According to the invention, the correction factor α is a function of the local isophote curvature α(κ). Thus the operator can also be expressed as: L_{ww}+α(κ)Lᵥᵥ. Using the equations give above, this can be rewritten to: L_{ww}−α(κ)κL_{w}. In systems where the blurring varies between images, it is preferred to use a correction factor that also depends on a degree of blurring. Preferably, the degree of blurring is expressed as a standard deviation of a function that is representative for the blurring of the acquisition device that has been used for acquiring the image. It is known that for many acquisition devices, the blurring can be modeled by a Gaussian point-spread function (PSF). The detailed description given below gives an optimal correction when the blurring is Gaussian, or when the Gaussian is a good approximation of the blurring function (e.g. like in CT images). Persons skilled in the art can apply he same principles to other blurring functions. The Gaussian PSF can be mathematically described as:

$$G = \frac{1}{{( \sqrt{2 {πσ}^{2}} )}^{N}} exp ( - \frac{\vec{r} \cdot \vec{r}}{2 {σ}^{2}} )$$

where σ is the standard deviation, N is the number of dimensions and \vec{r}·\vec{r} is the dot product of the position vector with itself. In Cartesian coordinates the position vector \vec{r}={x, y, z}^{T}. Defining the unblurred object as M, the blurred object L is defined as L=M*G (convolution).

Thus, in a preferred embodiment the correction factor α is a function of the local isophote curvature and of the standard deviation: α(κ, σ). In the remainder, it will be clear that it is sufficient to use a correction factor α that depends on the product of the local isophote curvature and the standard deviation: α(σκ), thus only one input value needs to be used. In the remainder, the function coefficients of α will usually not be shown. It will also be clear that the standard deviation may cover both the standard deviation of the blurring and of the Gaussian derivative.

In the following description, for the analysis and approximations of the correction factor function it is assumed that regions in the image are rather homogeneous. Therefore, edges can be modeled by the Heaviside unit step. Moreover, the curvature is assumed to be locally almost constant. Locally constant curvature means that the curvature is constant inside the footprint of the blurring function.

The model for the ideal α (that avoids dislocation of the zero crossing) in 2D is the solution of the equation: L_{ww}−ακL_{w}=0. The solution to this equation has been derived analytically for circular objects (disks) in 2D. For such objects, the optimal correction factor α is given by:

$$α ( σ , κ ) = 1 + {( \frac{1}{σκ} )}^{2} ( 1 - \frac{{I}_{0} ( {( \frac{1}{σκ} )}^{2} )}{{I}_{1} ( {( \frac{1}{σκ} )}^{2} )} )$$

where Iₙ( ) is the modified Bessel function of the first kind. This is valid for all objects as long as the curvature is (approximately) constant inside the footprint of the Gaussian.

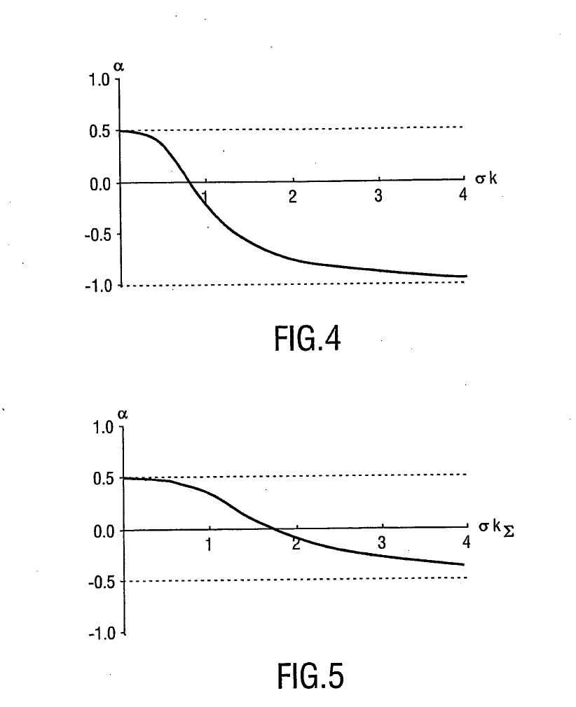

FIG. 4 illustrates this function. If σκ approaches zero, then α=0.5. It can be shown that for a constant α=0.5 the chosen operator is identical to the Plus operator. For σκ>0.5, the entire object is inside the center part of the Gaussian PSF. The given α avoids dislocation of the zero crossings for an object with locally constant curvature in 2D. The method according to the invention yields an unbiased disk detector.

The model for the ideal α (that avoids dislocation of the zero crossing) in 3D is the solution of the equation: L_{ww}−ακ_{Σ}L_{w}=0. The solution to this equation has been derived analytically for spherical objects (“balls”) and cylindrical objects in 3D, being the simplest objects in 3D with constant curvature with different ratios of κ₂/κ₁ (for a ball κ₂/κ₁=1 and for a cylinder κ₂/κ₁=0). For a ball, the correction factor α is given by:

$$α = \frac{2 {( \frac{2}{{σκ}_{Σ}} )}^{4} + 2 ( 1 - {e}^{2 {( \frac{2}{{σκ}_{Σ}} )}^{2}} ) + {( \frac{2}{{σκ}_{Σ}} )}^{2} ( 3 + {e}^{2 {( \frac{2}{{σκ}_{Σ}} )}^{2}} )}{2 ( 1 - {e}^{2 {( \frac{2}{{σκ}_{Σ}} )}^{2}} + {( \frac{2}{{σκ}_{Σ}} )}^{2} ( 1 + {e}^{2 {( \frac{2}{{σκ}_{Σ}} )}^{2}} ) )}$$

This correction factor α is also shown in FIG. 5. It can be used as an unbiased ball detector.

For a cylinder, the 3D Gaussian can be decomposed in one component in the direction of the central axis of a cylinder (z-direction) and two components in the cross-sectional plane. Because all derivatives in the z-direction are zero, the solution for the cylinder is similar to that of the disk. The correction factor α that avoids dislocation of the operator as a function of κ_{Σ} and σ is equivalent to the equation of the 2D disk given above, if the 2D κ is replaced by the 3D κ_{Σ}. This gives:

$$α ( σ , {κ}_{Σ} ) = 1 + {( \frac{1}{{σκ}_{Σ}} )}^{2} ( 1 - \frac{{I}_{0} ( {( \frac{1}{{σκ}_{Σ}} )}^{2} )}{{I}_{1} ( {( \frac{1}{{σκ}_{Σ}} )}^{2} )} )$$

This function can be used to quantify the diameter of tubular structures (like blood vessels) accurately.

From the two examples given above for 3D it will be understood that correction factor α is not invariant to the ratio of κ₂/κ₁. For randomly shaped objects, the sum of curvature components may not give enough information to correct for the dislocation of the curved surface. In a preferred embodiment, not only the sum of curvature components, but also the ratio between the curvature components is used to correct for the dislocation. These two coefficients allow the creation of a two-dimensional look-up table in a limited domain, with κ_{Σ} on one of the axis and κ₂/κ₁ on the other axis. A numerical approximation of the correction factor α is given as:

$$α ( {σκ}_{Σ} , \frac{{κ}_{2}}{{κ}_{1}} ) \approx \sim - 1 + \frac{{κ}_{2}^{2}}{2 {κ}_{1}^{2}} + ( \frac{3}{2} - \frac{{κ}_{2}^{2}}{2 {κ}_{1}^{2}} ) {e}^{\frac{{( {σκ}_{Σ} )}^{2}}{4}} ( 6.7 - 7.2 \cdot {1.0374}^{{( \frac{5}{2} - \frac{4 {κ}_{2}}{{κ}_{1}} )}^{2}} )$$

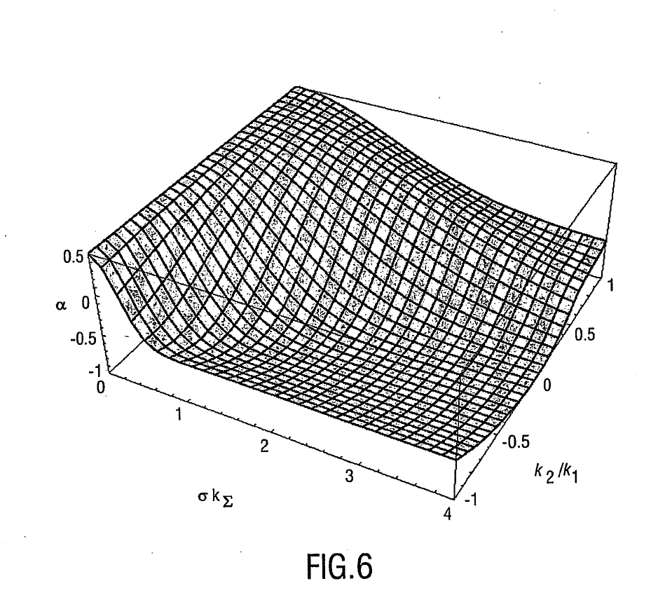

The function was obtained numerically with a toroidal object (donut)—as a model of a curved vessel—stored in a discrete data set FIG. 6 shows the approximation.

### Results

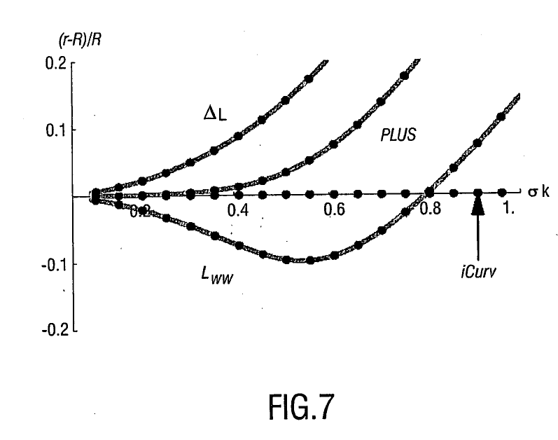

FIG. 7 shows experimental results, obtained in 2D with a circular object (radius R) stored in a discrete image. In this figure, the relative dislocation “(r−R)/R” is shown for various curvatures for the Laplacian (ΔL), the Plus operator (PLUS), second-order derivative in the gradient direction (L_{ww}) and the filter according to the invention, referred to as iCurv. As can be seen from the figure, the dislocation for the proposed filter is much lower than for other methods. In particular for higher curvatures, the method is significantly better.

The method according to the invention is computationally less intensive and more stable than many deconvolution methods. The method is not iterative (therefore fast compared to iterative deconvolution methods) and only derivatives up to second order are needed. The method can be automated (no manual segmentation is needed).

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for locating an edge of an object in a two- or three dimensional image, in particular a medical image; the system including:
an input (310) for receiving a set of data elements representing values of elements of the image;
a storage (320) for storing the data set;
an output (330) for providing an indication of a location of an edge in the image; and
a processor (340) for, under control of a computer program, processing the data set to determine the edge of an object in the image by:
calculating at least a first- and/or second-order derivative of the data elements;
calculating isophote curvatures for the image where the curvatures are identified by κ;
determining a correction factor α that corrects for dislocation of an edge caused by curvature of an object and/or blurring of the data; the correction factor α depending on the isophote curvature κ; and
determining a zero crossing of an operator that depends on the calculated derivative and the isophote curvature.

2. A system as claimed in claim 1, wherein:
the image has been acquired with an acquisition device (315) causing acquired data to be blurred; the correction factor α also depending on a degree of blurring of the image.

3. A system as claimed in claim 2, wherein the blurring substantially corresponds to a convolution with a Gaussian point-spread function with a standard-deviation σ and the correction factor α depends on the standard-deviation σ of the Gaussian blurring function.

4. A system as claimed in claim 2, wherein the processor is operative to determine for the image an associated estimated degree of blurring and to load for the image a correction factor function associated with the degree of blurring for the image; the correction factor function giving for an isophote curvature input value a corresponding correction factor value.

5. A system as claimed in claim 1, wherein the derivative is a Gaussian derivative and the operator is given by: L_{ww}−ακL_{w}, where w is a gradient direction.

6. A system as claimed in claim 3, wherein for a 2D image, α is given by:
$$α ( σ , κ ) = 1 + {( \frac{1}{σκ} )}^{2} ( 1 - \frac{{I}_{0} ( {( \frac{1}{σκ} )}^{2} )}{{I}_{1} ( {( \frac{1}{σκ} )}^{2} )} )$$
where Iₙ( ) is the modified Bessel function of the first kind.

7. A system as claimed in claim 3, wherein for a 3D image the isophote curvature κ includes a first curvature component κ₁ in a direction of a highest absolute value of the curvature and a second curvature component κ₂ in a direction perpendicular to κ₁, the correction factor α depending on κ_{Σ}=κ₁+κ₂.

8. A system as claimed in claim 7, wherein the correction factor α further depends on
$$\frac{{κ}_{1}}{{κ}_{2}} .$$

9. A method of locating an edge of an object in a two- or three-dimensional image, in particular a medical image; the method including:
receiving a set of data elements representing values of elements of the image;
calculating at least a first- and/or second-order derivative of the data elements;
calculating isophote curvatures for the image where the curvatures are identified by κ;
determining a correction factor α that corrects for dislocation of an edge caused by curvature of an object and/or blurring of the data; the correction factor α depending on the isophote curvature κ; and
determining the edge of an object in the image at a location in the image that corresponds to a zero crossing of an operator that depends on the calculated derivative and the isophote curvature.

10. A computer program product operative to cause a processor to perform the method as claimed in claim 9.
